(19) United States
(12) Patent Application Publication
(10) Pub. No.: US 2023/0172106 A1
(43) Pub. Date: Jun. 8, 2023

(54) HARVESTERS, HARVESTING HEADERS, AND METHODS OF OPERATING AGRICULTURAL MACHINES USING CROP LIFTERS

(71) Applicant: AGCO International GmbH, Neuhausen (CH)

(72) Inventors: Paolo Turcato, Breganze (IT); Andrea Dal Soglio, Breganze (IT)

(21) Appl. No.: 17/906,676

(22) PCT Filed: Jun. 10, 2021
(86) PCT No.: PCT/IB2021/055100

§ 371 Date: Sep. 19, 2022

(30) Foreign Application Priority Data
Jun. 30, 2020 (GB) 2009977.6

(51) Int. Cl. A01D 41/14; A01D 41/127; A01D 65/02

(52) U.S. Cl. CPC A01D 41/141; A01D 41/127; A01D 65/02

(57) ABSTRACT

A harvesting header includes a header frame, at least one cutting tool carried by the header frame, and at least one crop lifter extending forward of the cutting tool. The crop lifter is coupled to the header frame by a rotatable arm. At least one sensor coupled to the crop lifter is configured to measure an angle of the rotatable arm relative to the header frame. A crop-harvesting machine includes a chassis, a feederhouse, a processing system, a grain bin, a harvesting header, and a control system configured to adjust a position of the harvesting header based at least in part on the measured angle of the rotatable arm. A method of operating a crop-harvesting machine includes determining an angle of the rotatable arm of the crop lifter relative to the header frame and adjusting a height of the harvesting header based at least in part on the angle.

### CROSS-REFERENCE TO RELATED APPLICATION

This application claims the benefit of the filing date of U. K. Patent Application 2009977.6, “Harvesters, Harvesting Headers, and Methods of Operating Agricultural Machines Using Crop Lifters,” filed Jun. 30, 2020, the entire disclosure of which is incorporated herein by reference.

### FIELD

This disclosure relates to harvesting headers for use with self-propelled crop-harvesting machines, and particularly to headers having crop lifters leading a cutting tool.

### BACKGROUND

Self-propelled agricultural harvesters are well known and include, by way of example, combine harvesters, windrowers, and forage harvesters. FIG. 1 is a simplified side view of a combine harvester 10, which included a frame 12 or chassis, an operator cab 14, an engine, and ground-engaging wheels 16 or tracks. A cutting or pick-up header 18 carried by the combine harvester 10 is used to cut crop, and may be considerably wider than the combine harvester 10 and mounted to the front side of a feederhouse 20.

Crop material collected by the header 18 is conveyed into the feederhouse 20 before being conveyed in a generally rearward direction to crop-processing apparatus. In the case of a combine harvester, the processing apparatus serves to thresh the crop material and separate grain therefrom, whereas, in the case of a forage harvester or windrower, the crop material is typically passed through conditioning rollers.

As depicted in FIG. 1, the header 18 may contact the ground in certain terrain (e.g., hilly, rough, rocky, etc.). Contact between the header 18 and the ground may cause damage to the header 18, and harvesting operations may be stopped to repair or clean the header 18. Operators may adjust harvesting speed and/or header height in difficult terrain to limit or minimize damage to the header 18. A height sensor 22 (e.g., a drag rod) may be carried by the header 18 to detect changes in terrain, as described in, for example, U.S. Pat. No. 7,647,753, “Header Height Control System and Method,” granted Jan. 19, 2010.

### BRIEF SUMMARY

A harvesting header for use with a crop-harvesting machine includes a header frame structured to be coupled to a front of the crop-harvesting machine, at least one cutting tool carried by the header frame, and at least one crop lifter extending forward of the cutting tool and configured to direct crop material rearward and upward over the cutting tool. The crop lifter is coupled to the header frame by a rotatable arm. The header includes at least one sensor coupled to the crop lifter and configured to measure an angle of the rotatable arm relative to the header frame.

A crop-harvesting machine includes a chassis, a feederhouse carried by the chassis, a processing system carried by the chassis and structured to receive crop material from the feederhouse, a grain bin carried by the chassis and structured to receive processed grain from the processing system, a harvesting header coupled to the feederhouse and configured to cut grain, and a control system configured to adjust a position of the harvesting header relative to the chassis. The harvesting header includes a header frame, at least one cutting tool carried by the header frame, and at least one crop lifter extending forward of the cutting tool and configured to direct crop material rearward and upward over the cutting tool. The crop lifter is coupled to the header frame by a rotatable arm. The header also includes at least one sensor coupled to the crop lifter and configured to measure an angle of the rotatable arm relative to the header frame. The control system adjusts the position of the harvesting header based at least in part on the measured angle of the rotatable arm.

A method of operating an agricultural harvester includes propelling the crop-harvesting machine through an agricultural field, determining an angle of the rotatable arm of the crop lifter relative to the header frame, and adjusting a height of the harvesting header based at least in part on the angle of the rotatable arm.

### BRIEF DESCRIPTION OF THE DRAWINGS

While the specification concludes with claims particularly pointing out and distinctly claiming what are regarded as embodiments of the present disclosure, various features and advantages of embodiments of the disclosure may be more readily ascertained from the following description of example embodiments of the disclosure when read in conjunction with the accompanying drawings, in which:

FIG. 1 is a simplified side view of a prior art combine harvester and header;

FIG. 2 is a simplified side view of a combine harvester having a header with a crop lifter;

FIG. 3 is a detailed side view of the harvesting header shown in FIG. 2;

FIG. 4 is a detailed side view of the harvesting header shown in FIG. 2 on different terrain; and

FIG. 5 is a simplified flow chart illustrating a method of operating an agricultural harvester.

### DETAILED DESCRIPTION

The illustrations presented herein are not actual views of any header or portion thereof, but are merely idealized representations that are employed to describe example embodiments of the present disclosure. Additionally, elements common between figures may retain the same numerical designation.

The following description provides specific details of embodiments of the present disclosure in order to provide a thorough description thereof. However, a person of ordinary skill in the art will understand that the embodiments of the disclosure may be practiced without employing many such specific details. Indeed, the embodiments of the disclosure may be practiced in conjunction with conventional techniques employed in the industry. In addition, the description provided below does not include all elements to form a complete structure or assembly. Only those process acts and structures necessary to understand the embodiments of the disclosure are described in detail below. Additional conventional acts and structures may be used. Also note, the drawings accompanying the application are for illustrative purposes only, and are thus not drawn to scale.

As used herein, the terms “comprising,” “including,” “containing,” “characterized by,” and grammatical equivalents thereof are inclusive or open-ended terms that do not exclude additional, unrecited elements or method steps, but also include the more restrictive terms “consisting of” and “consisting essentially of” and grammatical equivalents thereof.

As used herein, the term “may” with respect to a material, structure, feature, or method act indicates that such is contemplated for use in implementation of an embodiment of the disclosure, and such term is used in preference to the more restrictive term “is” so as to avoid any implication that other, compatible materials, structures, features, and methods usable in combination therewith should or must be excluded.

As used herein, the term “configured” refers to a size, shape, material composition, and arrangement of one or more of at least one structure and at least one apparatus facilitating operation of one or more of the structure and the apparatus in a predetermined way.

As used herein, the singular forms following “a,” “an,” and “the” are intended to include the plural forms as well, unless the context clearly indicates otherwise.

As used herein, the term “and/or” includes any and all combinations of one or more of the associated listed items.

As used herein, spatially relative terms, such as “beneath,” “below,” “lower,” “bottom,” “above,” “upper,” “top,” “front,” “rear,” “left,” “right,” and the like, may be used for ease of description to describe one element's or feature's relationship to another element(s) or feature(s) as illustrated in the figures. Unless otherwise specified, the spatially relative terms are intended to encompass different orientations of the materials in addition to the orientation depicted in the figures.

As used herein, the term “substantially” in reference to a given parameter, property, or condition means and includes to a degree that one of ordinary skill in the art would understand that the given parameter, property, or condition is met with a degree of variance, such as within acceptable manufacturing tolerances. By way of example, depending on the particular parameter, property, or condition that is substantially met, the parameter, property, or condition may be at least 90.0% met, at least 95.0% met, at least 99.0% met, or even at least 99.9% met.

As used herein, the term “about” used in reference to a given parameter is inclusive of the stated value and has the meaning dictated by the context (e.g., it includes the degree of error associated with measurement of the given parameter).

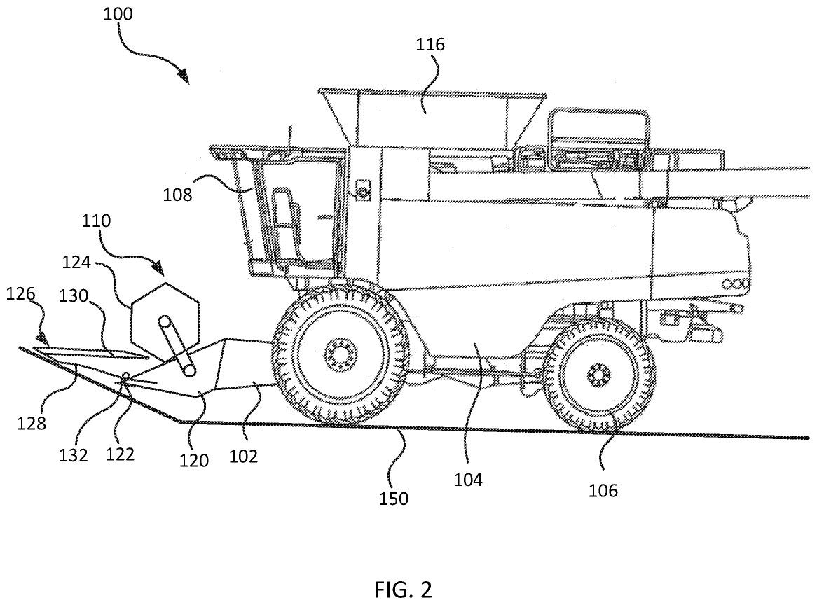

FIG. 2 illustrates an example agricultural harvester embodied as a combine harvester 100. In the context of the present disclosure, the example combine harvester 100 is merely illustrative, and other machines and/or implements with like functionality may deploy certain embodiments disclosed herein, such as windrowers, forage harvesters, etc. The combine harvester 100 includes a feederhouse 102 carried by a chassis 104 supported by wheels 106. In some embodiments, other or additional forms of travel may be used, such as tracks. An operator cab 108 is mounted to the chassis 104. The feederhouse 102 may move (e.g., up and down, pitch, tilt, etc.) based on actuation of hydraulic cylinders connecting the feederhouse 102 to the chassis 104, which causes a detachably coupled header 110 to also be raised, lowered, pitched, and/or tilted. Mechanical power may be provided to the header 110 by a mechanical shaft, hydraulic lines, or other systems, during operation of the combine harvester 100.

In general, the header 110 cuts crop materials, and the cut crop materials are delivered to the front end of the feederhouse 102. Such crop materials are moved upwardly and rearwardly within and beyond the feederhouse 102 (e.g., by a conveyer) until reaching a processing system in the combine harvester 100. The processing system processes the crop materials in known manner and passes a portion of the crop material (e.g., heavier chaff, corn stalks, etc.) toward the rear of the combine harvester 100 and another portion (e.g., grain and possibly light chaff) through a cleaning process. Cleaned grain is delivered to a grain bin 116 located at the top of the combine harvester 100. In embodiments in which the agricultural harvester is a windrower or forage harvester, the processing system may include conditioning rollers rather than separation devices, and the grain bin 116 may be omitted.

The header 110 includes a header frame 120 carrying at least one cutting tool 122. The cutting tool 122 may be a cutterbar having at least one oscillating blade, or any other tool used for harvesting crops that come into contact with the cutting tool 122. The header 110 may also include side drapers, a center draper, and/or a collecting auger that together may transport cut crop material toward the feederhouse 102 of the combine harvester 100. Headers are described in more detail in, for example, U.S. Pat. No. 7,886,511, “Draper Head with Flexible Cutterbar Having Rigid Center Section,” issued Feb. 15, 2011; U.S. Pat. No. 10,194,588, “Corn header Configured to Reduce Kernel Losses,” issued Feb. 5, 2019; and U.S. Pat. No. 8,857,143, “Frame for Harvesting Header with Continuous Section,” issued Oct. 14, 2014.

The header frame 120 may also carry a reel 124 configured to direct crop material toward the cutting tool 122 and at least one crop lifter 126 configured to lead the cutting tool 122 when the header 110 is carried by the combine harvester 100 through an agricultural field.

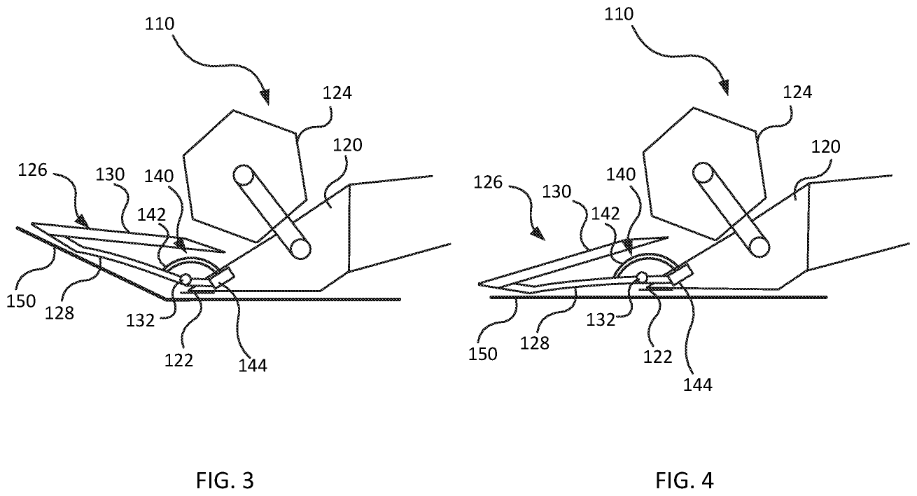

The crop lifter 126 may include a rotatable arm 128 rigidly connected to a lifting finger 130. FIG. 3 is a more detailed view of the header 110, including the crop lifter 126, at a point where the crop lifter 126 has encountered a hill, but the header 110 has not yet been raised. The rotatable arm 128 of the crop lifter 126 is pivotally coupled to the header frame 120 or the cutting tool 122 at a pivot point 132, such that the crop lifter 126 can remain in contact with the ground 150 (i.e., the soil surface) even when the ground 150 is not flat. As depicted, the pivot point 132 is fixed to a forward extension secured to the header frame 120. In other embodiments, the pivot point 132 may be fixed directly to the header frame 120 or to a fixed part of the cutting tool 122. The rotatable arm 128 leads the cutting tool 122 and carries the lifting finger 130 toward uncut crop material. The lifting finger 130 directs the uncut crop material rearward and upward over the cutting tool 122, such that the cutting tool 122 may cut the crop material near the roots and stems. The lifting finger 130 extends rearward from a forward point of the rotatable arm 128 over the cutting tool 122.

The header frame 120 may also carry a sensor 140 coupled to the crop lifter 126. For example, the sensor 140 may include an angular deflector 142 configured to measure an angle of the rotatable arm 128 relative to the header frame 120. In some embodiments, the angular deflector 142 may include a spring to urge the crop lifter 126 downward. In other embodiments, a separate spring may urge the crop lifter 126 downward. In still other embodiments, the crop lifter 126 may rely simply on gravity to remain against the ground 150. The sensor 140 may include a transmitter 144 configured to generate a signal correlated to the angular orientation of the rotatable arm 128. The signal may be transmitted (e.g., via wired or wireless connection) to a control system associated with the combine harvester 100 (e.g., a computer having a user interface in the operator cab 108). The control system may use the angle of the crop lifter 126 to determine a contour of the ground 150 and adjust the angle and/or height of the header frame 120 accordingly.

FIG. 4 illustrates the header frame 120 on different terrain than in FIG. 3. In particular, the surface of the ground 150 is angled upward in FIG. 3, and is level in FIG. 4. As shown, the crop lifter 126 moves responsive to the ground surface. Thus, the sensor 140 detects a change in the position of the crop lifter 126 relative to the header frame 120. The combine harvester 100 may then change the position of the header frame 120 to keep the cutting tool 122 at a selected distance from the ground surface.

As shown in FIG. 3, the crop lifter 126 reaches a hill or other change in terrain ahead of the cutting tool 122. The rotatable arm 128 rotates upward, and the sensor 140 detects a change in the angle of the rotatable arm 128. The transmitter 144 transmits a signal to the control system of the combine harvester 100, which may then adjust a height of the header frame 120 based on the detected topography that the cutting tool 122 is about to encounter.

Though depicted as having a movable rotary arm (i.e., the angular deflector 142), the sensor 140 may in some embodiments be a rotational sensor located at the pivot point 132 connecting the crop lifter 126 to the header frame 120.

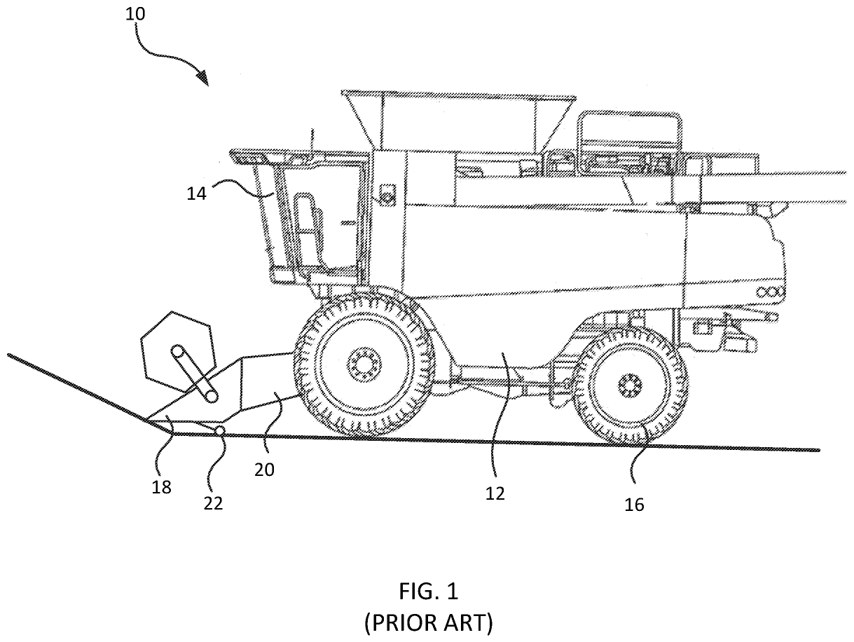

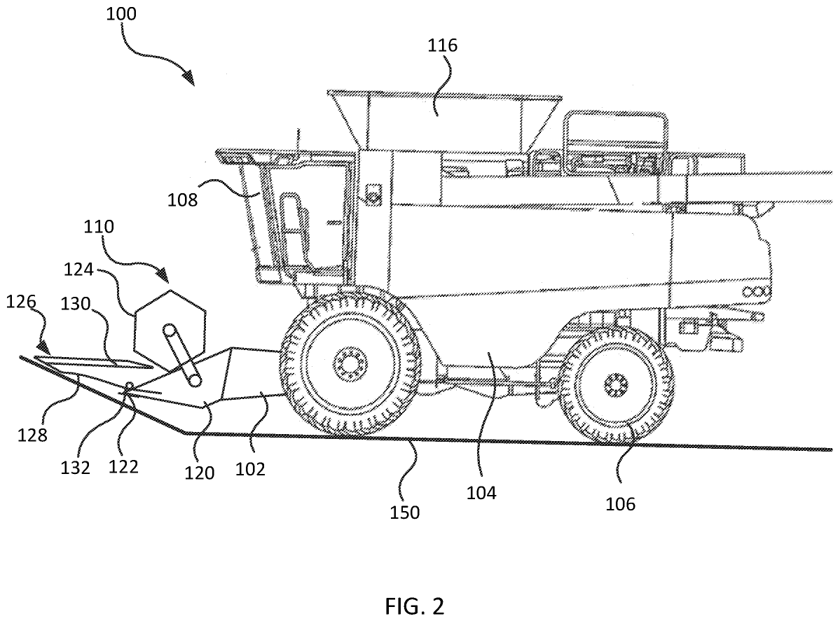

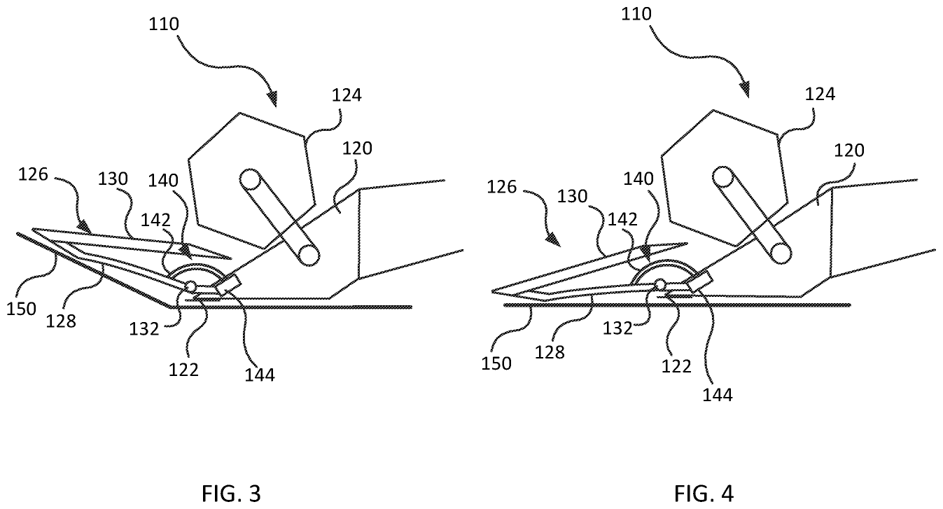

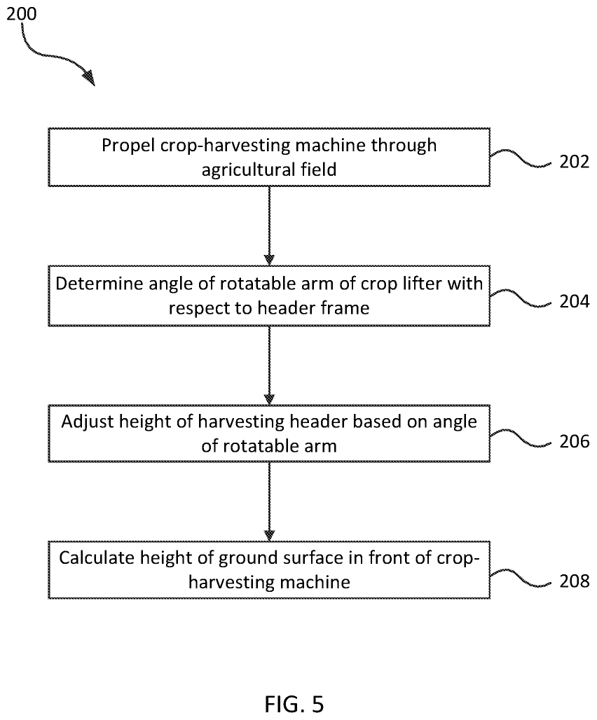

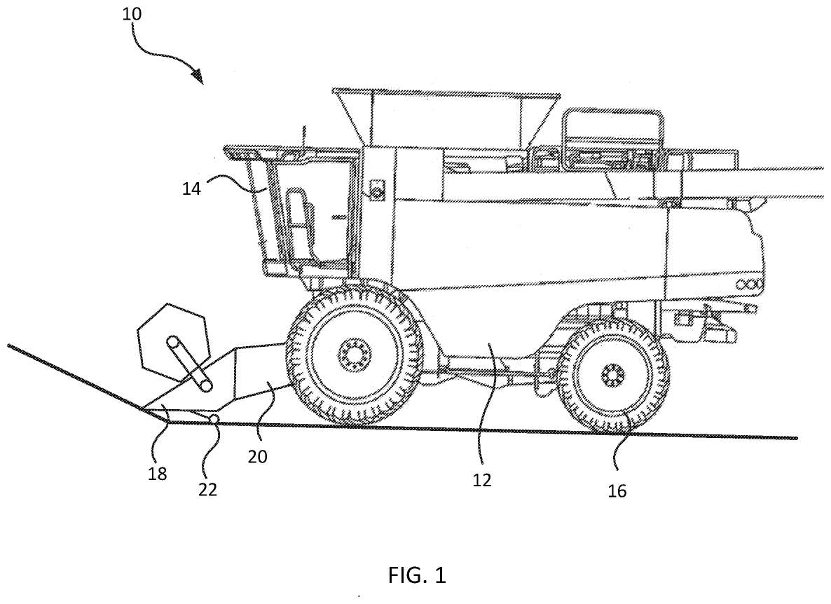

A benefit of the sensor 140, as compared to a height sensor 22 (FIG. 1) trailing a cutting tool, is that the combine harvester 100 can determine the contour of the ground in front of the cutting tool 122. Furthermore, the sensor 140 may be used in conjunction with the height sensor 22 to provide additional data (i.e., the sensors 22, 140 may be used as verification of one another). Typically, the sensor 140 in combination with the crop lifter 126 can measure the ground approximately 35 cm to 40 cm in front of the cutting tool 122. Thus, the header frame 120 may be adjusted to avoid contacting the ground with the cutting tool 122, and to avoid damage to the cutting tool 122. This may improve the performance of the combine harvester 100 by decreasing downtime and enabling the cutting tool 122 to be operated closer to the ground. Furthermore, because the sensor 140 can provide constant information to the combine harvester 100 about the ground contour, the combine harvester 100 may travel faster than the operator could manually adjust the header frame 120 in response to contours ahead.

Another benefit of the sensor 140 is that crop lifters may already be used for harvesting certain crops (e.g., bushy or viny crops that grow close to the ground). Thus, in fields where it is beneficial to operate the cutting tool 122 close to the ground, a crop lifter 126 is likely to be beneficial to lift the drop upward to cut. Thus, using the sensor 140 in conjunction with the crop lifter 126 allows additional functionality (forward-looking surface detection) without additional crop-engaging hardware (i.e., the sensor 140 need not itself contact the crop or the ground 150).

The control system may cause the feederhouse 102 to raise the header frame 120 to match the contour of the ground 150, such that the cutting tool 122 does not touch the ground 150. The sensor 140 may enable the operator to set the desired minimum distance from the cutting tool 122 to the ground 150 lower than is desired for conventional harvesting headers because the sensor 140 (in combination with the control system) may protect the cutting tool 122 from damage. That is, by moving the header frame 120 when a change in the elevation of the ground 150 is detected, the combine harvester 100 may avoid contacting the cutting tool 122 with the ground 150. Furthermore, by automating the process of adjusting the height of the header 110, the operator may harvest an agricultural field faster and more safely than with conventional equipment, because adjustments may be made while the operator remains in the operator cab 108.

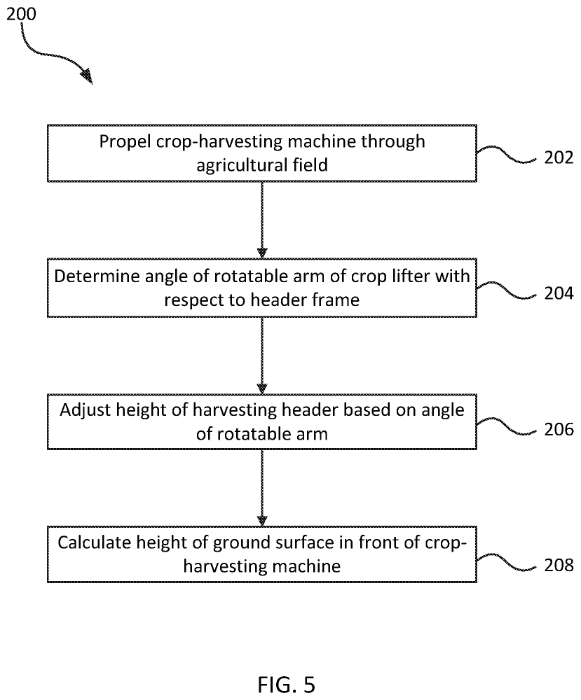

FIG. 5 is a simplified flow chart illustrating a method 200 in which the header 110 may be used to harvest an agricultural field. In block 202, a crop-harvesting machine is propelled through an agricultural field.

In block 204, an angle of the rotatable arm 128 relative to the header frame 120 is determined. In block 206, a height of the harvesting header is adjusted based on the angle. The height may be adjusted to avoid contacting the soil surface with the cutting tool 122, or to maintain a selected height of the cutting tool 122 relative to the soil surface. In block 208, the height of the ground surface in front of the crop-harvesting machine is calculated.

Though depicted as a flow chart, the actions in FIG. 5 may be performed concurrently, and in some embodiments, some actions may be omitted.

The sensors disclosed herein may be used to direct a control system to move the harvesting header to prevent contact with the ground and to keep the harvesting header at a selected height for harvesting. Typically, if a harvesting tool contacts the ground, the harvesting tool may be damaged. Furthermore, rocks and other debris can damage harvesting tools. To avoid these problems, the height of a conventional harvesting header may typically be set high enough to avoid ground contact and debris. However, this height may be greater than is ideal for certain crops. Thus, the sensors disclosed herein may enable the operator to set the height of the harvesting header lower than would be possible with conventional harvesting headers, yet the sensors may help avoid damage caused by terrain variations or rocks.

Though one sensor 140 is depicted on the harvesting header 110, multiple sensors 140 may be placed on a single harvesting header 110. For example, one sensor 140 may be mounted to each of an array of crop lifters 126 spaced along the header 110 (e.g., spaced about 30 cm apart) to provide contour information at various points. The sensors 140 may each be configured to detect deviations of ±15 cm from a neutral position (i.e., the position of the crop lifter 126 on level ground.

Additional non-limiting example embodiments of the disclosure are described below.

Embodiment 1: A harvesting header for use with a crop-harvesting machine, the harvesting header comprising a header frame structured to be coupled to a front of the crop-harvesting machine, at least one cutting tool carried by the header frame, and at least one crop lifter extending forward of the at least one cutting tool and configured to direct crop material rearward and upward over the at least one cutting tool. The at least one crop lifter is coupled to the header frame by a rotatable arm, and at least one sensor is coupled to the at least one crop lifter and configured to measure an angle of the rotatable arm relative to the header frame.

Embodiment 2: The harvesting header of Embodiment 1, wherein the at least one sensor is configured to provide a signal to the crop-harvesting machine.

Embodiment 3: The harvesting header of Embodiment 2, wherein the signal is correlated to the angle of the rotatable arm.

Embodiment 4: The harvesting header of Embodiment 1, wherein the at least one cutting tool comprises a cutterbar having at least one oscillating blade.

Embodiment 5: The harvesting header of Embodiment 1, wherein the at least one crop lifter is pivotally connected to the at least one cutting tool.

Embodiment 6: The harvesting header of Embodiment 1, wherein the crop lifter further comprises a lifting finger carried by the rotatable arm, wherein the lifting finger extends rearward from the rotatable arm over the at least one cutting tool.

Embodiment 7: A crop-harvesting machine comprising a chassis, a feederhouse carried by the chassis, a processing system carried by the chassis and structured to receive crop material from the feederhouse, a grain bin carried by the chassis and structured to receive processed grain from the processing system, and a harvesting header coupled to the feederhouse and configured to cut grain. The harvesting header comprises a header frame, at least one cutting tool carried by the header frame, and at least one crop lifter extending forward of the at least one cutting tool and configured to direct crop material rearward and upward over the at least one cutting tool. The at least one crop lifter is coupled to the at least one cutting tool by a rotatable arm and at least one sensor is coupled to the header frame and configured to measure an angle of the rotatable arm relative to the header frame. A control system is configured to adjust a position of the harvesting header relative to the chassis based at least in part on the measured angle of the rotatable arm.

Embodiment 8: The crop-harvesting machine of Embodiment 7, wherein the sensor is configured to transmit a signal to the control system.

Embodiment 9: The crop-harvesting machine of Embodiment 8, wherein the signal is correlated to a minimum distance from the harvesting header to the soil surface.

Embodiment 10: A method of operating a crop-harvesting machine carrying the harvesting header of any one of Embodiment 1 through Embodiment 6, the method comprising propelling the crop-harvesting machine through an agricultural field, determining an angle of the rotatable arm of the at least one crop lifter relative to the header frame, and adjusting a height of the harvesting header based at least in part on the angle of the rotatable arm.

Embodiment 11: The method of Embodiment 10, further comprising calculating a height of a ground surface in front of the crop-harvesting machine.

Embodiment 12: The method of Embodiment 11, wherein calculating a height of a ground surface comprises calculating the height of the ground surface based on the angle of the rotatable arm.

Embodiment 13: The method of any one of Embodiment 10 through Embodiment 12, wherein adjusting the height of the harvesting header comprises raising the harvesting header to avoid contacting the soil surface with the at least one cutting tool.

Embodiment 14: The method of any one of Embodiment 10 through Embodiment 13, wherein adjusting the height of the harvesting header comprises maintaining a selected height of the at least one cutting tool relative to the soil surface.

All references cited herein are incorporated herein in their entireties. If there is a conflict between definitions herein and in an incorporated reference, the definition herein shall control.

While the present disclosure has been described herein with respect to certain illustrated embodiments, those of ordinary skill in the art will recognize and appreciate that it is not so limited. Rather, many additions, deletions, and modifications to the illustrated embodiments may be made without departing from the scope of the disclosure as hereinafter claimed, including legal equivalents thereof. In addition, features from one embodiment may be combined with features of another embodiment while still being encompassed within the scope as contemplated by the inventors. Further, embodiments of the disclosure have utility with different and various machine types and configurations.

1. A harvesting header for use with a crop-harvesting machine, the harvesting header comprising:
a header frame structured to be coupled to a front of the crop-harvesting machine;
at least one cutting tool carried by the header frame;
at least one crop lifter extending forward of the at least one cutting tool and configured to direct crop material rearward and upward over the at least one cutting tool, wherein the at least one crop lifter is coupled to the header frame by a rotatable arm; and
at least one sensor coupled to the at least one crop lifter and configured to measure an angle of the rotatable arm relative to the header frame.

2. The harvesting header of claim 1, wherein the at least one sensor is configured to provide a signal to the crop-harvesting machine.

3. The harvesting header of claim 2, wherein the signal is correlated to the angle of the rotatable arm.

4. The harvesting header of claim 1, wherein the at least one cutting tool comprises a cutterbar having at least one oscillating blade.

5. The harvesting header of claim 1, wherein the at least one crop lifter is pivotally connected to the at least one cutting tool.

6. The harvesting header of claim 1, wherein the crop lifter further comprises a lifting finger carried by the rotatable arm, wherein the lifting finger extends rearward from the rotatable arm over the at least one cutting tool.

7. A crop-harvesting machine, comprising:
a chassis;
a feederhouse carried by the chassis;
a processing system carried by the chassis and structured to receive crop material from the feederhouse;
a grain bin carried by the chassis and structured to receive processed grain from the processing system;
a harvesting header coupled to the feederhouse and configured to cut grain, the harvesting header comprising:
a header frame;
at least one cutting tool carried by the header frame;
at least one crop lifter extending forward of the at least one cutting tool and configured to direct crop material rearward and upward over the at least one cutting tool, wherein the at least one crop lifter is coupled to the at least one cutting tool by a rotatable arm; and
at least one sensor coupled to the header frame and configured to measure an angle of the rotatable arm relative to the header frame; and
a control system configured to adjust a position of the harvesting header relative to the chassis based at least in part on the measured angle of the rotatable arm.

8. The crop-harvesting machine of claim 7, wherein the sensor is configured to transmit a signal to the control system.

9. The crop-harvesting machine of claim 8, wherein the signal is correlated to a minimum distance from the harvesting header to the soil surface.

10. A method of operating a crop-harvesting machine carrying the harvesting header of claim 1, the method comprising:
propelling the crop-harvesting machine through an agricultural field;
determining an angle of the rotatable arm of the at least one crop lifter relative to the header frame; and
adjusting a height of the harvesting header based at least in part on the angle of the rotatable arm.

11. The method of claim 10, further comprising calculating a height of a ground surface in front of the crop-harvesting machine.

12. The method of claim 11, wherein calculating a height of a ground surface comprises calculating the height of the ground surface based on the angle of the rotatable arm.

13. The method of claim 10, wherein adjusting the height of the harvesting header comprises raising the harvesting header to avoid contacting the soil surface with the at least one cutting tool.

14. The method of claim 10, wherein adjusting the height of the harvesting header comprises maintaining a selected height of the at least one cutting tool relative to the soil surface.
